(19) United States
(12) Patent Application Publication
(10) Pub. No.: US 2019/0253930 A1
(43) Pub. Date: Aug. 15, 2019

(54) RESOURCE MANAGEMENT APPARATUS, RESOURCE MANAGEMENT METHOD, AND PROGRAM

(71) Applicant: NEC CORPORATION, Tokyo (JP)

(72) Inventors: Masatoshi SENJU, Tokyo (JP); Yuka SUGANO, Tokyo (JP); Minoru TOMOBE, Tokyo (JP); Shinobu SASAKI, Tokyo (JP); Masashi SHIMOMA, Tokyo (JP)

(73) Assignee: NEC CORPORATION, Tokyo (JP)

(21) Appl. No.: 16/319,023

(22) PCT Filed: Jul. 21, 2016
(86) PCT No.: PCT/JP2016/071361

§ 371 Date: Jan. 18, 2019

(51) Int. Cl. H04W 28/08; H04W 72/04; H04W 8/08; H04W 24/08; H04W 88/16; H04W 4/70; G06F 9/455

(52) U.S. Cl. CPC H04W 28/08; H04W 72/0486; H04W 8/08; G06F 2009/45595; H04W 88/16; H04W 4/70; G06F 9/45558; H04W 24/08

(57) ABSTRACT

A resource management apparatus includes: a first section for monitoring, in a virtual network configured by virtualizing at least one first device that handles a control plane of the network and at least one second device that handles a user plane of the network, load statuses of the virtual first and second devices; and a second section for adjusting physical resources allocated to the virtual first and second devices, based on the load statuses of the virtual first and second devices.

### CROSS REFERENCE TO RELATED APPLICATIONS

This Application is a National Stage of International Application No. PCT/JP2016/071361 filed Jul. 21, 2016.

### FIELD

The present invention relates to a resource management apparatus, a resource management method, and a program. In particular, it relates to a resource management apparatus, a resource management method, and a program that manage resources allocated to devices virtualized on a virtual network.

### BACKGROUND

Recent years have seen widespread use of smartphones, smart devices, etc., and the communication traffic has been increasing rapidly. In addition, since communications referred to as Internet-of-things (IoT) communications and machine-to-machine (M2M) communications are expected to grow in the future, there is no doubt that the communication traffic will increase further. This increase in the communication traffic makes it important to enhance facilities of the network nodes that process the communication traffic.

Patent Literature 1 discloses a technique that generates, in a mobile communication system including physical servers realizing virtual call processing nodes, an individual virtual call processing node based on the processing amount of communication processing per physical server. More specifically, according to Patent Literature 1, by generating an individual virtual call processing node based on the processing amount of communication processing per physical server, the necessary resources for the communication processing are secured, and the facility use efficiency is enhanced.

Non-Patent Literature 1 is a white paper of Network Functions Virtualisation (NFV) relating to an exemplary embodiment of the present invention. Non-Patent Literature 2 is an explanatory document on the architectural framework of the NFV.

### CITATION LIST

### Patent Literature

Patent Literature 1: Japanese Patent No. JP5537600

### Non-Patent Literature

Non-Patent Literature 1: European Telecommunications Standards Institute (ETSI), “Network Functions Virtualisation—Update White Paper”, [online], [Searched on May 27, 2016], Internet <URL: https://portal.etsi.org/NFV/NFV_White_Paper2.pdf>
Non-Patent Literature 2: European Telecommunications Standards Institute (ETSI), “Network Functions Virtualisation; Architectural Framework (ETSI GS NFV 002)”, [online], [Searched on May 27, 2016], Internet <URL: http://www.etsi.org/deliver/etsi_gs/nfv/001_099/002/01.01.01_60/gs_nfv002v010101p.pdf>

### SUMMARY

The following analysis has been made by the present inventors. As described above, according to the technique described in Patent Literature 1, a virtual call processing node is generated based on the processing amount of communication processing per physical server. However, according to the technique described in Patent Literature 1, these virtual nodes are not generated in view of the load status(es) of the individual virtual node(s) generated in the corresponding physical server(s). Depending on the load status(es) of the individual virtual node(s), delay could occur in signal processing in the individual virtual node(s).

Communications referred to as IoT communications and M2M communications have a feature in which a small amount of data flows through the user plane (which will hereinafter be referred to as the “U-Plane”) and a large amount of data flows through the control plane (which will hereinafter be referred to as the “C-Plane”). In situations where there are more communications referred to as IoT communications and M2M communications, such control based on the processing amount of communication processing per physical server as described in Patent Literature 1 is presumed to be unable to achieve an efficient operation.

It is an object of the present invention to provide a resource management apparatus, a resource management method, and a program that contribute to efficient allocation of resources to a virtual network used for a communication referred to as an IoT communication or an M2M communication.

According to a first aspect, there is provided a resource management apparatus including a first section for monitoring, in a virtual network configured by virtualizing at least one first device that handles a control plane of the network and at least one second device that handles a user plane of the network, load statuses of the virtual first and second devices. This resource management apparatus also includes a second section for adjusting physical resources allocated to the virtual first and second devices, based on the load statuses of the virtual first and second devices.

According to a second aspect, there is provided a resource management method including: causing a resource management apparatus connected to a virtual network configured by virtualizing at least one first device that handles a control plane of the network and at least one second device that handles a user plane of the network to monitor load statuses of the virtual first and second devices; and causing the resource management apparatus to adjust physical resources allocated to the virtual first and second devices, based on the load statuses of the virtual first and second devices. The present method is associated with a certain machine referred to as a resource management apparatus that manages resources allocated to devices virtualized on a virtual network.

According to a third aspect, there is provided a program, causing a computer constituting a resource management apparatus connected to a virtual network configured by virtualizing at least one first device that handles a control plane of the network and at least one second device that handles a user plane of the network to perform processing for: monitoring load statuses of the virtual first and second devices; and adjusting physical resources allocated to the virtual first and second devices, based on the load statuses of the virtual first and second devices. This program can be stored in a computer-readable (non-transient) storage medium. Namely, the present invention can be embodied as a computer program product.

The meritorious effects of the present invention are summarized as follows.

The present invention contributes to efficient allocation of resources to a virtual network used for a communication referred to as an IoT communication or an M2M communication. In addition, the present invention can convert a resource management apparatus described in Background into a resource management apparatus that can improve efficiency of resources allocation to a virtual network used for a communication referred to as an IoT communication or an M2M communication.

### BRIEF DESCRIPTION OF THE DRAWINGS

FIG. 1 illustrates a configuration according to an exemplary embodiment of the present disclosure.

FIG. 2 illustrates an operation according to the exemplary embodiment of the present disclosure.

FIG. 3 illustrates an operation according to the exemplary embodiment of the present disclosure.

FIG. 4 illustrates an overall configuration according to a first exemplary embodiment of the present disclosure.

FIG. 5 illustrates a configuration example of a server that provides virtual network functions corresponding to virtual network nodes according to the first exemplary embodiment of the present disclosure.

FIG. 6 illustrates a configuration example of a VNF configured by the server according to the first exemplary embodiment of the present disclosure.

FIG. 7 illustrates a configuration example of a control part in the server in FIG. 5.

FIG. 8 illustrates a configuration example of a controller according to the first exemplary embodiment of the present disclosure.

FIG. 9 illustrates an example of load status information about shared nodes managed by a load status storage part in the controller according to the first exemplary embodiment of the present disclosure.

FIG. 10 illustrates a coordination operation between the controller and the server in FIG. 5 according to the first exemplary embodiment of the present disclosure.

FIG. 11 illustrates another configuration example of the server that provides virtual network functions corresponding to virtual network nodes according to the first exemplary embodiment of the present disclosure.

FIG. 12 illustrates another configuration example of the server that provides virtual network functions corresponding to virtual network nodes according to the first exemplary embodiment of the present disclosure.

FIG. 13 illustrates another configuration example of the server that provides virtual network functions corresponding to virtual network nodes according to the first exemplary embodiment of the present disclosure.

FIG. 14 illustrates another configuration example of the server that provides virtual network functions corresponding to virtual network nodes according to the first exemplary embodiment of the present disclosure.

FIG. 15 is a sequence diagram illustrating an operation according to the first exemplary embodiment of the present disclosure.

FIG. 16 illustrates an overall configuration according to a second exemplary embodiment of the present disclosure.

FIG. 17 illustrates a detailed configuration example according to the second exemplary embodiment of the present disclosure.

FIG. 18 illustrates a relationship between a load status managed by an NFV-MANO and a threshold according to the second exemplary embodiment of the present disclosure.

### PREFERRED MODES

First, an outline of an exemplary embodiment of the present disclosure will be described with reference to drawings. In the following outline, various components are denoted by reference characters for the sake of convenience. Namely, the following reference characters are merely used as examples to facilitate understanding of the present disclosure, not to limit the present disclosure to the illustrated modes. In addition, an individual connection line between blocks in any of the drawings, etc. to which the following description refers signifies both one-way and two-way directions. An individual arrow schematically illustrates the principal flow of a signal (data) and does not exclude bidirectionality.

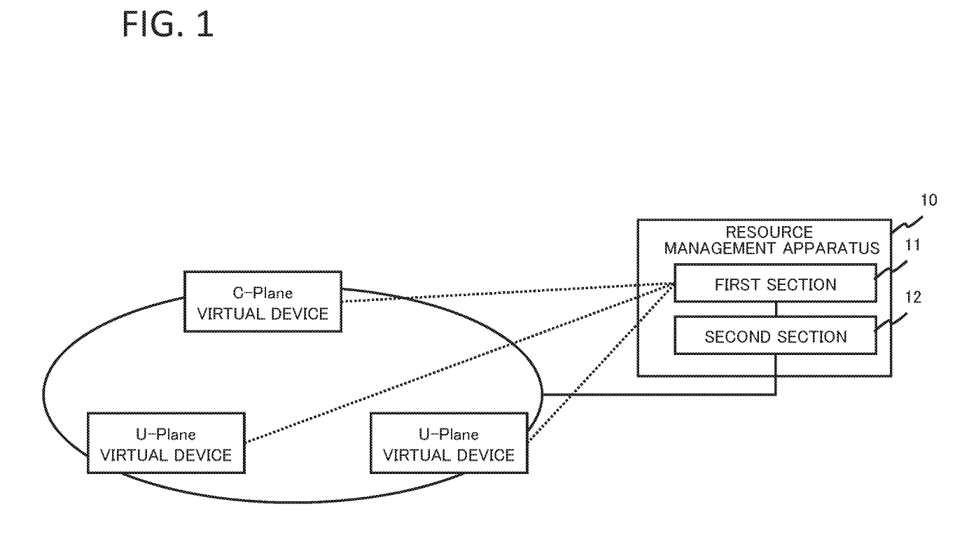

As illustrated in FIG. 1, an exemplary embodiment of the present disclosure can be realized by a resource management apparatus that includes a first section 11 and a second section 12.

More specifically, the first section 11 monitors, in a virtual network configured by virtualizing at least one first device that handles a control plane of the network (see “a C-Plane virtual device” in FIG. 1) and at least one second device that handles a user plane of the network (see “U-Plane virtual devices” in FIG. 1), load statuses of the virtual first and second devices.

The second section 12 adjusts physical resources allocated to the virtual first and second devices, based on the load statuses of the virtual first and second devices.

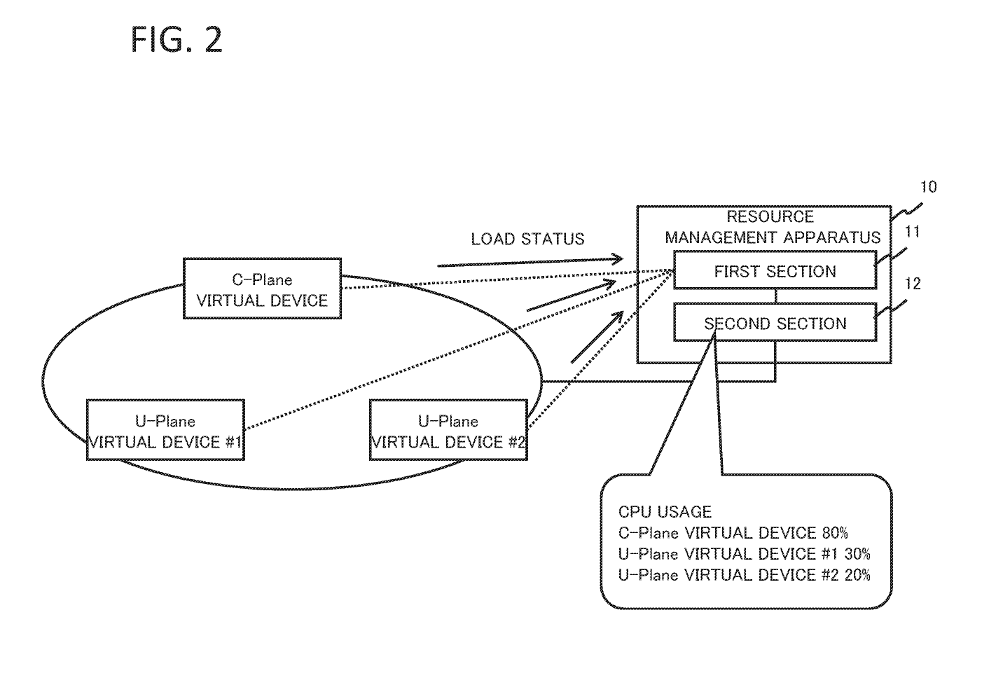

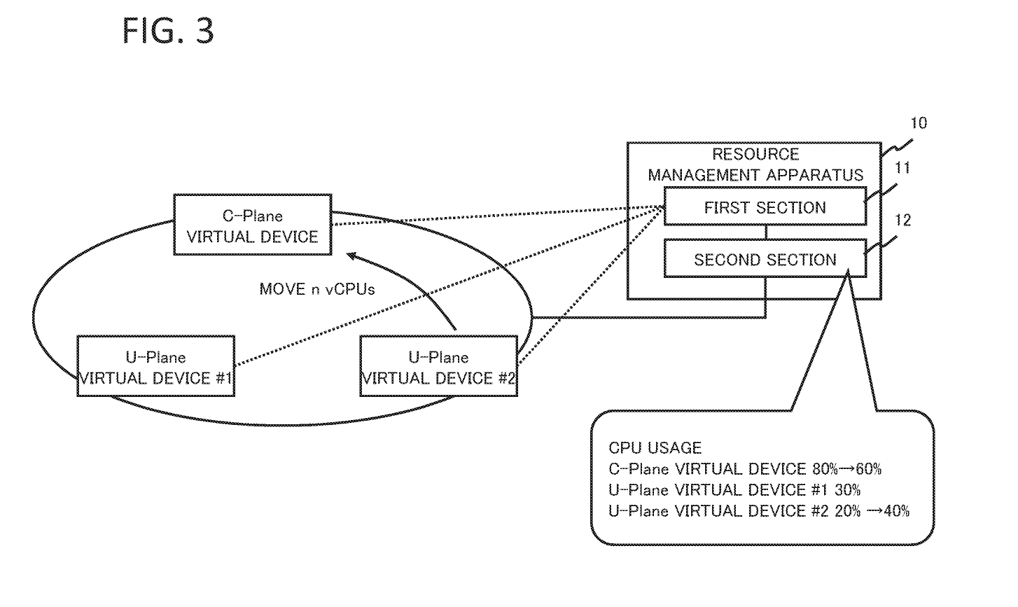

For example, FIG. 2 illustrates a case in which the CPU (central processing unit) usage of the C-Plane virtual device is 80%, which is greater than a predetermined threshold 70%, and the CPU usages of the U-Plane virtual devices #1 and #2 are 30% and 20%, respectively. In this case, as illustrated in FIG. 3, the second section 12 moves (reallocates) resources (for example, vCPUs) of one of the U-Plane virtual devices to the C-Plane virtual device. In this way, it is possible to drop the CPU usage of the C-Plane virtual device, for example, from 80% to 60% without using any additional resources.

In addition, in the above communication referred to as an IoT communication or an M2M communication, namely in a network in which sensor data observed by predetermined sensor devices flow, when this kind of traffic occurs, movement of resources from the U-Plane to the C-Plane as described above can be performed. In the communication referred to as an IoT communication or an M2M communication, low speed and high latency are generally allowed. Thus, the above processing contributes to efficient use of the overall network resources.

### First Exemplary Embodiment

Next, a first exemplary embodiment will be described in detail with reference to drawings. In the first exemplary embodiment, the present disclosure is applied to management of resources in a virtual mobile core network that can accommodate Long Term Evolution (LTE). The scope of the application of the present disclosure is not limited to EPC.

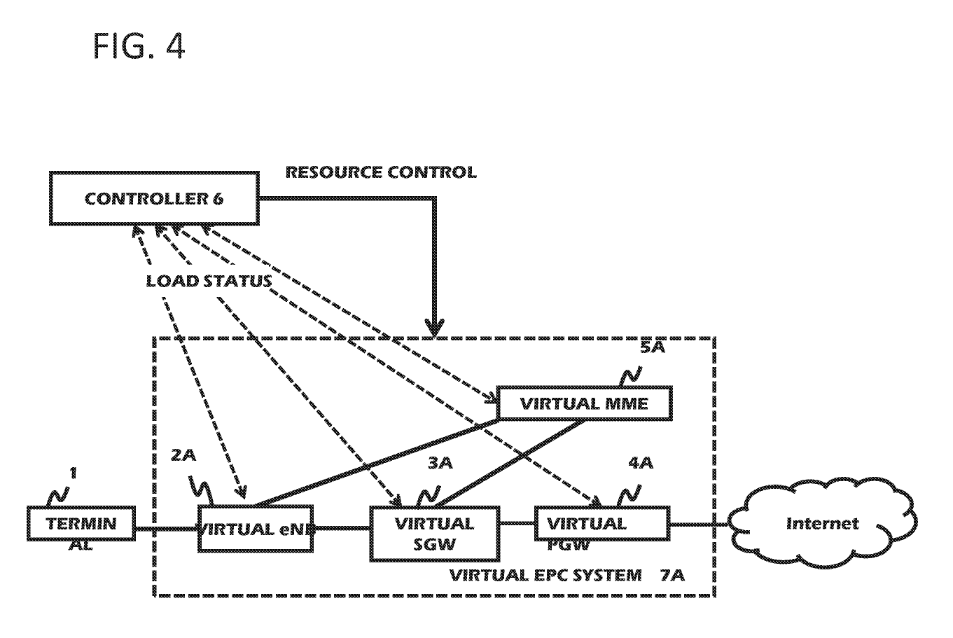

FIG. 4 illustrates an overall configuration according to the first exemplary embodiment of the present disclosure. In the example in FIG. 4, the overall configuration according to the first exemplary embodiment includes a terminal 1 (a user equipment (UE)) and a plurality of kinds of virtual devices (virtual network nodes) constituting a virtual EPC (Evolved Packet Core) system. The terminal 1 communicates with an external network such as the Internet via the plurality of kinds of virtual devices (virtual network nodes).

The example in FIG. 4 illustrates a configuration in which a virtual base station (a virtual eNB) 2A, a virtual Serving Gateway (a virtual SGW) 3A, a virtual Packet Data Network Gateway (a virtual PGW) 4A, and a virtual Mobility Management Entity (a virtual MME) 5A are arranged as the virtual devices (virtual network nodes). While the example in FIG. 4 illustrates the virtual eNB 2A, the virtual SGW 3A, the virtual PGW 4A, and the virtual MME 5A, other virtual devices may be arranged.

Examples of the terminal 1 include a portable phone, a personal computer (PC), a mobile router, a smart device (for example, a smart meter monitoring household power consumption, a smart TV, a wearable terminal), and an M2M (machine-to-machine) device. Examples of the M2M device include, in addition to the above devices, an industrial device, a vehicle, a healthcare device, and a household appliance. The terminal 1 accesses the Internet or the like via the core network (the virtual EPC system) by connecting to the virtual eNB 2A.

For management of radio resources, in addition to a function (a C-Plane function) of processing control signaling, the virtual eNB 2A has a function (a U-Plane function) of performing data communication with the terminal 1, for example, based on the packet data convergence protocol (PDCP).

Other than serving as an anchor point for terminal mobility, for example, the virtual SGW 3A has a function (a user-plane function) of processing packets as a gateway that handles the user plane and a function (a C-Plane function) of processing control signaling.

Other than serving as a point of contact with an external network, for example, the virtual PGW 4A has a function (a user-plane function) of processing packets as a gateway that handles the user plane, a function (a policy and charging enforcement function (PCEF)) of managing a charging state based on a communication, a function (a policy and charging rule function (PCRF)) of controlling policies such as QoS, a lawful interception (LI)) function of intercepting a communication, etc.

As a management entity, the virtual MME 5A controls signaling between the terminal and the core network and performs bearer management. Specifically, the virtual MMEs 5A has a function (a C-Plane function) of processing control signaling such as setting and releasing of communication sessions and controlling of handovers and a function of managing information about subscribers of a communication system in coordination with a home subscriber server (HSS).

Individual network functions executed by the virtual devices such as the virtual eNB 2A, the virtual SGW 3A, the virtual PGW 4A, and the virtual MME 5A (unless these devices need to be distinguished from each other for some reasons, these devices will hereinafter be referred to as “virtual network nodes”) are realized by software of virtual machines that operate on a virtual server(s) (the virtual server(s) will be described below). Dynamic scale-out and scale-in are possible for these network functions executed on the virtual machines.

A controller 6 requests a virtual server to perform dynamic scale-out/scale-in on a corresponding network function, based on load information acquired from a corresponding virtual network node. For example, based on the load status of the virtual MME 5A, the controller 6 determines excess or deficiency of the resource amounts allocated to the virtual MME 5A and requests dynamic scale-out/scale-in on the virtual MME 5A. Thus, according to the present exemplary embodiment, the controller 6 serves as a resource management apparatus.

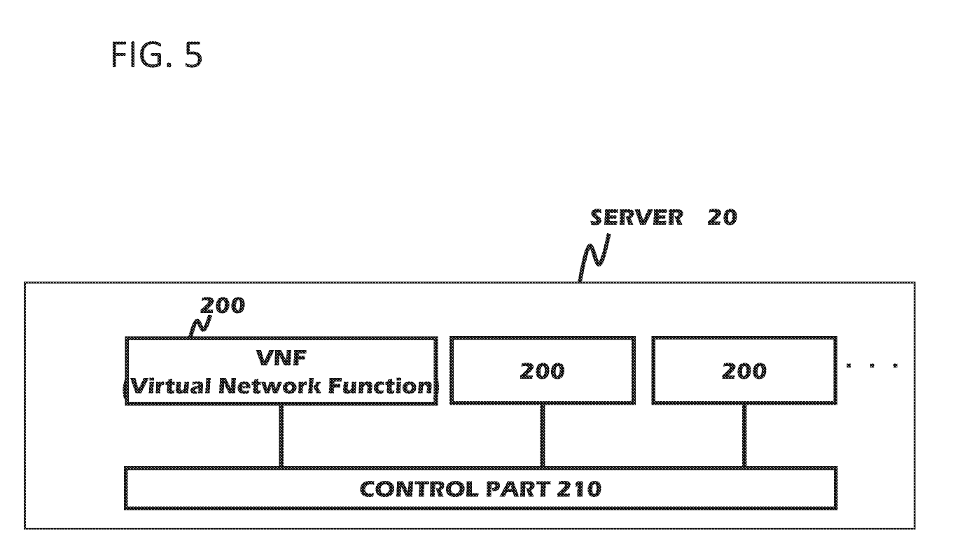

FIG. 5 illustrates a configuration example of a virtual server (which will simply be referred to as a “server 20”) that provides virtual network functions corresponding to virtual network nodes according to the first exemplary embodiment of the present disclosure. As illustrated in FIG. 5, for example, the server 20 includes a control part 210 and virtual network functions (VNFs) 200. In FIG. 5, while the server 20 is illustrated as the apparatus that includes the virtual network nodes, a router or the like may be used as the apparatus that includes the virtual network nodes.

The control part 210 can operate a network function(s) executed on a virtual network node(s) on a virtual machine(s) as a VNF(s) 200. For example, a VNF 200 can operate as a virtual network node such as the virtual eNB 2A, the virtual MME 5A, the virtual SGW 3A, the virtual PGW 4A, or the like. However, the control part 210 can execute other functions on the virtual machines.

For example, the control part 210 may be configured by control software that can execute computer virtualization, such as a hypervisor.

The control part 210 can forward a received signal to a VNF 200 and cause the VNF 200 to perform signal processing based on a function of this VNF 200. Examples of the received signal include communication data (packets, etc.) exchanged via a bearer and a control message exchanged between virtual network nodes.

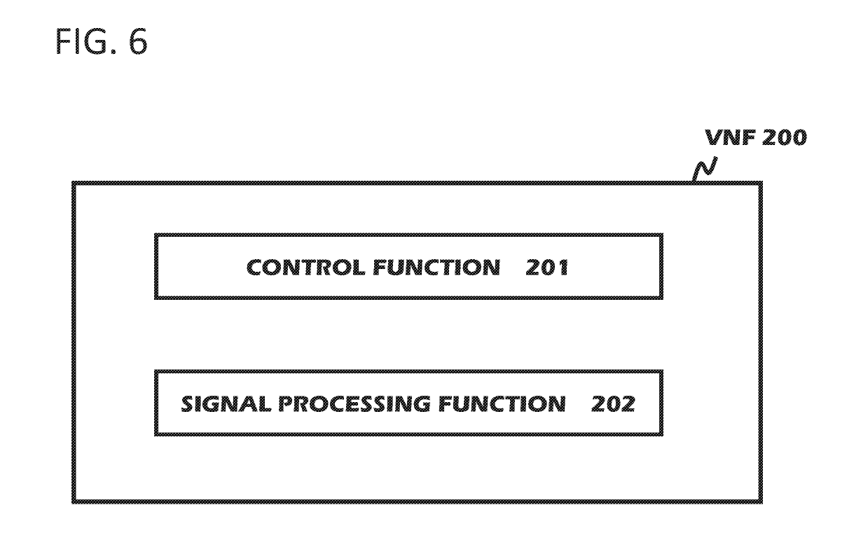

FIG. 6 illustrates a configuration example of a VNF configured by the server 20 according to the first exemplary embodiment of the present disclosure. For example, an individual VNF 200 includes a control function 201 and a signal processing function 202. The control function 201 and the signal processing function 202 are equivalent to functions of a control part and a signal processing part of a device constituting an eNB, an MME, an SGW, a PGW, or the like.

The control function 201 performs so-called C-Plane processing. For example, the control function 201 processes control signals transmitted in the virtual EPC system.

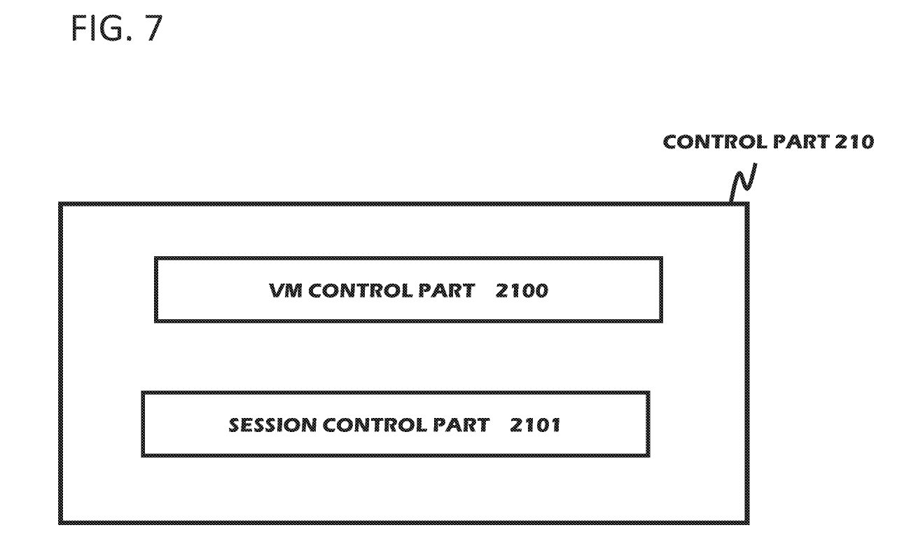

The signal processing function 202 performs so-called U-Plane processing. For example, the signal processing function 202 processes data transmitted in the virtual EPC system. FIG. 7 illustrates a configuration example of the control part in the server 20 in FIG. 5. The control part 210 includes, for example, a virtual machine (VM) control part 2100 and a session control part 2101.

The VM control part 2100 controls the virtual machines for operating the VNFs 200 corresponding to signal processing executed by the virtual network nodes. For example, the VM control part 2100 can execute at least one of activation, removal, and stoppage of an individual virtual machine. In addition, for example, the VM control part 2100 may be configured to migrate an active virtual machine to another virtual machine.

For example, in response to a request from the controller 6, the VM control part 2100 controls activation, stoppage, migration, or the like on a virtual machine. For example, in response to a request from the controller 6, the VM control part 2100 dynamically performs activation, stoppage, migration, or the like on a virtual machine. At an event other than reception of a request from the controller 6, the VM control part 2100 may control activation, stoppage, migration, or the like on a virtual machine, for example, based on a situation in the virtual EPC system. For example, the VM control part 2100 may dynamically perform activation, stoppage, migration, or the like on a virtual machine based on the communication amount or the congestion situation in the virtual EPC system or based on the load of the server 20.

The session control part 2101 can forward a received signal to a VNF 200 corresponding to this signal. In addition, the session control part 2101 can forward a signal issued by a VNF 200 to a destination corresponding to this signal.

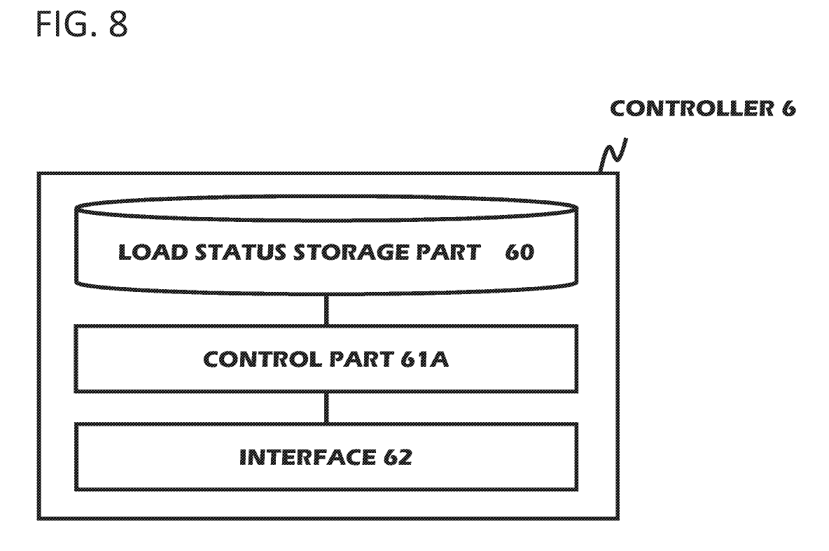

FIG. 8 illustrates a configuration example of the controller 6 according to the first exemplary embodiment of the present disclosure. As illustrated in FIG. 8, the controller 6 includes a load status storage part 60, a control part 61A, and an interface 62.

The control part 61A in the controller 6 has a function of performing provisioning of resources of the virtual network nodes constituting the virtual EPC system. The control part 61A collects the load statuses from the respective virtual network nodes and stores the collected load statuses in the load status storage part 60.

The interface 62 is an interface for communicating with the individual virtual network nodes. The controller 6 can communicate with the virtual eNB 2A and the virtual MME 5A via the interface 62 by using a predetermined protocol. The controller 6 collects the load statuses from the respective virtual network nodes via the interface 62, for example.

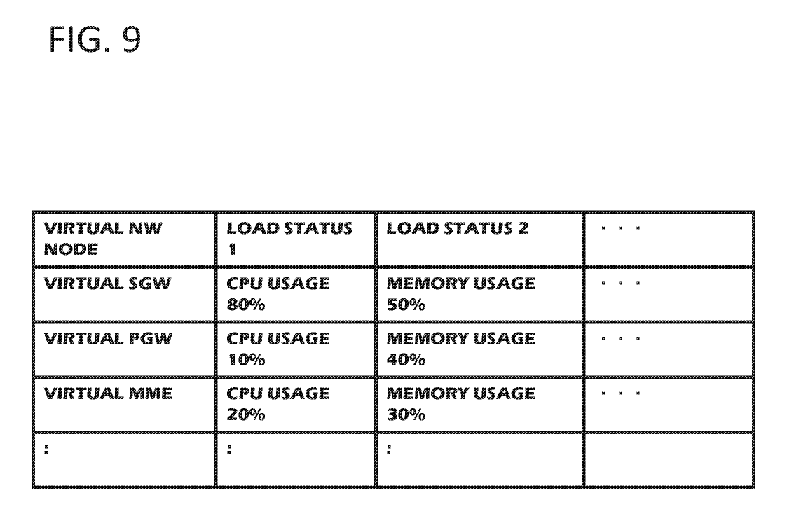

The load status storage part 60 stores the load information collected from the virtual network nodes per virtual network node, for example. FIG. 9 illustrates an example of the load status information about the virtual network nodes managed by the load status storage part 60. The load information about the virtual network nodes is collected at predetermined time intervals and stored in the load status storage part 60. While the virtual SGW 3A, the virtual PGW 4A, and the virtual MME 5A are used as the monitoring targets in the example in FIG. 9, load information about other virtual network nodes may be collected and stored.

The control part 61A calculates the resource amounts of the virtual network nodes, the amounts being necessary to satisfy predetermined conditions, based on the load statuses of the virtual network nodes stored in the load status storage part 60. In the case of the resource amounts of a virtual network node, the amounts being necessary to satisfy predetermined conditions, for example, the control part 61A calculates necessary resource amounts such that a value indicating the load status of this virtual network node satisfies predetermined conditions (for example, the CPU usage is XX % or less and the memory usage is YY % or less).

Based on the calculated resource amounts and the excess and deficiency statuses of the actually allocated resources, the control part 61A performs provisioning of the resources of the virtual network node. For example, based on the resource amounts for satisfying the predetermined conditions, the control part 61A requests the server 20 operating the corresponding virtual machine to additionally allocate resources (server resources, CPU resources, network resources, etc.) to the corresponding virtual network node. For example, the control part 61A calculates resource amounts such that the virtual MME 5A satisfies the predetermined conditions and requests the server 20 to allocate the lacking resources to the virtual MME 5A.

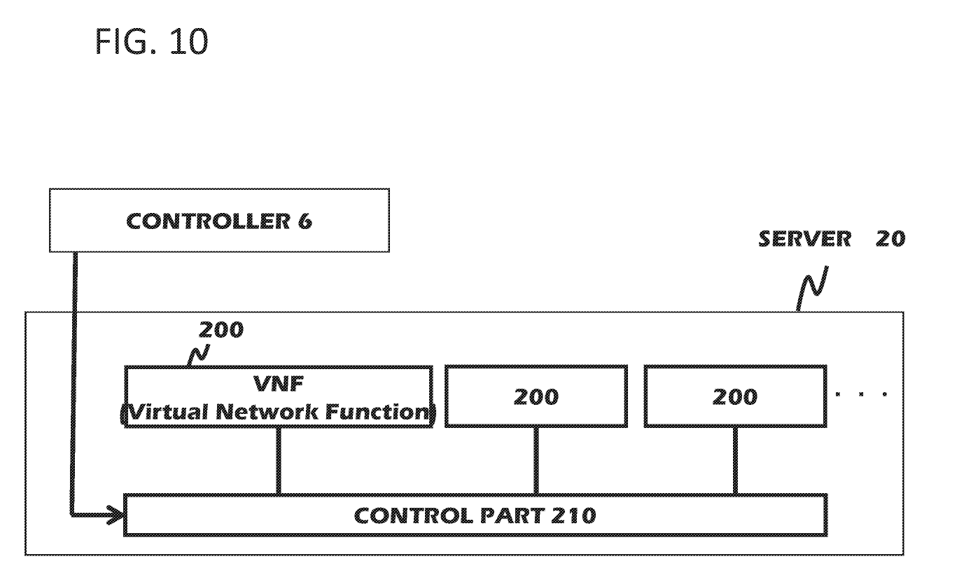

FIG. 10 illustrates an operation in which the controller 6 provisions resources to virtual network nodes in the server 20 according to the first exemplary embodiment. As illustrated in FIG. 10, the controller 6 requests the control part 210 in the server 20 to perform provisioning on resources (server resources, CPU resources, network resources, etc.) of virtual network nodes. Specifically, based on previously calculated future resource amounts of the virtual MME 5A, the control part 61A requests the server 20 operating the corresponding virtual machine to allocate resources to the virtual MME 5A or to reserve allocation of resources.

In response to the request from the control part 61A in the controller 6, the control part 210 in the server 20 allocates the resources to the corresponding virtual network node on the corresponding virtual machine or reserves allocation of the resources. For example, when addition of resources to the virtual MME 5A is requested, the control part 210 additionally allocates the resource amounts requested by the control part 61A to the virtual MME 5A operating on the virtual machine.

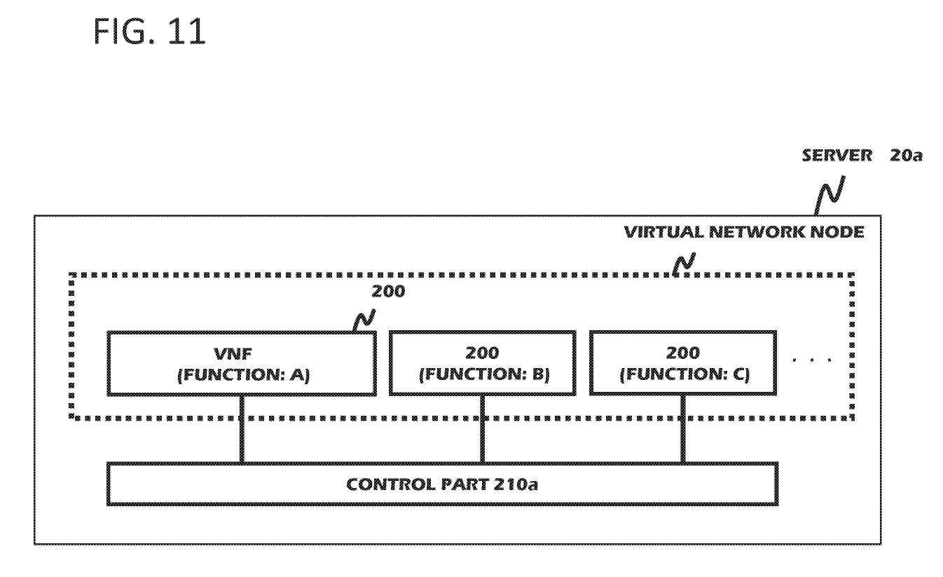

Hereinafter, some variations of the above server 20 will be described. FIG. 11 illustrates another configuration example of the server 20 according to the first exemplary embodiment. As illustrated in FIG. 11, a control part 210a in a server 20a according to another configuration example can realize an individual one of a plurality of sub-functions (for example, functions A to C in FIG. 11) of a virtual network node in the virtual EPC system by using one of a plurality of VNFs corresponding to the respective sub-functions. Namely, the control part 210a in FIG. 11 controls virtual machines such that the VNFs 200 corresponding to the respective sub-functions are provided.

Examples of the sub-functions of the virtual network nodes include the follows functions.

### (1) Sub-functions of a Virtual PGW:

a function of processing packets (User-Plane function)
a function of managing a charging state based on a communication (PCEF: Policy and Charging Enforcement Function)
a function of controlling policies such as QoS (PCRF: Policy and Charging Rule Function)
a function of intercepting a communication (LI: Lawful Interception)

### (2) Sub-functions of a Virtual SGW:

a function of processing packets (User-Plane function)
a function of processing control signaling (C-Plane function)

### (3) Sub-functions of a Virtual MME:

a function of processing control signaling (C-Plane function): for example, setting and releasing of communication sessions, controlling of handovers, etc.
a function of managing information about subscribers of a communication system in coordination with a home subscriber server (HSS)
   (4) Sub-functions of a virtual eNB:
a function of processing digital baseband signals
a function of processing analog radio frequency (RF) signals

According to this another configuration example, the control part 210a controls a virtual machine executing a VNF 200 for each of the above sub-functions. In response to a request from the controller 6, the control part 210a can allocate resources to a virtual machine executing a VNF 200 for each of the above sub-functions.

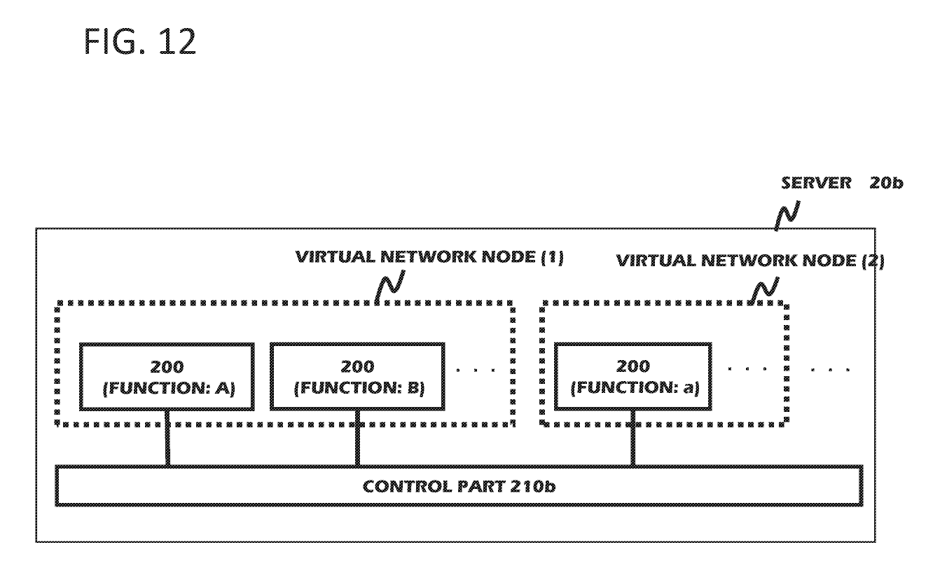

FIG. 12 illustrates another configuration example of the server 20 according to the first exemplary embodiment. As illustrated in FIG. 12, a control part 210b in a server 20b according to this another configuration example operates a plurality of kinds of virtual network nodes (virtual network nodes (1) and (2) in FIG. 12) on the virtual EPC system on virtual machines. Specifically, in response to a request from the controller 6, the control part 210b causes the server 20b to realize a plurality of sub-functions of a plurality of kinds of virtual network nodes by using respective VNFs. In addition, the control part 210b allocates resources to the virtual machines executing the respective virtual network nodes.

In addition, in the configurations in FIGS. 5 and 10 to 12, the VNFs 200 may be arranged separately in a plurality of servers 20. For example, in the example in FIG. 11, the VNFs 200 corresponding to functions “A” and “B” may be arranged in a server 20 (1), and the VNF 200 corresponding to function “C” may be arranged in another server 20 (2). In this case, the controller 6 requests the control parts in the servers in which the VNFs 200 are arranged to allocate resources to the virtual machines executing their respective VNFs 200.

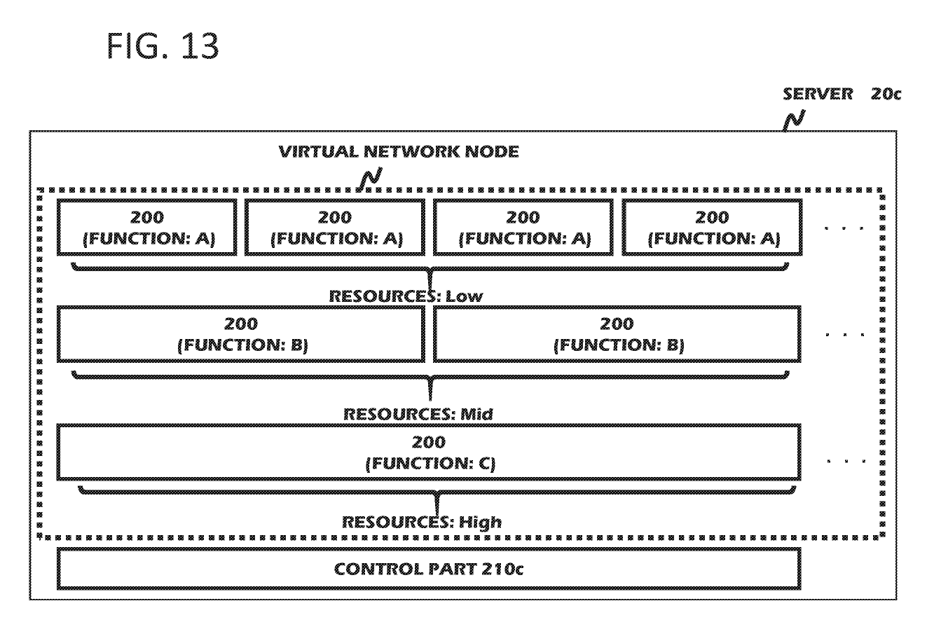

FIG. 13 illustrates another configuration example of the server 20 according to the first exemplary embodiment. A control part 210c controls computing resources allocated to virtual machines corresponding to VNFs 200 based on functions provided by the VNFs 200. In the example in FIG. 13, based on the functions (functions “A” to “C” in FIG. 13) provided by the VNFs 200, a VM control part in the control part 210c changes distribution of computing resources allocated to the VNFs 200. In the example in FIG. 13, based on the functions of the VNFs 200, the VM control part in the control part 210c controls the resource amounts (“Low”, “Mid”, and “High” in FIG. 13) allocated to the VNFs 200. The change of the resource amounts allocated based on the functions of the VNFs 200 in FIG. 13 can be realized by, for example, previously determining standard resource amounts for the functions of the VNFs 200.

Communications referred to as IoT communications and M2M communications have a feature in which a small amount of data flows through the user plane and a large amount of data flows through the control plane. By using the configuration as illustrated in FIG. 13, of all the VNFs 200, a VNF(s) 200 that performs processing relating to the control plane can be set to belong to a group to which larger resource amounts (High) are allocated. However, in this case, the resource use efficiency could be deteriorated as the entire system. By coordinating with the controller 6 according to the present exemplary embodiment, the server 20c can set the VNF(s) that performs processing relating to the control plane to belong to a group to which smaller resource amounts (Low) are allocated and can increase the allocated resource amounts only when necessary by performing provisioning.

In addition, there are cases in which virtual network nodes are requested to manage their communication statuses that change based on signal processing. For example, the virtual MME 5A includes a function of managing bearer context, which is described, for example, in chapter 5.7 in a document (TS 13.401 V 12.3.0) relating to technological specifications about radio communication (3GPP: 3rd Generation Partnership Project). In addition, for example, the virtual PGW 4A includes a function of managing charging based on a communication amount.

In this way, in a case where a VNF 200 manages a communication status, for example, when the VM control part in the control part 210c migrates this VNF 200 to a different virtual machine, the VM control part also migrates the communication status of this VNF 200 to the different virtual machine. When a communication status has a larger information amount, more time is needed to migrate the communication status. Thus, the performance of the communication service relating to the migrating VNF 200 is expected to deteriorate. Therefore, for example, when a VNF(s) 200 provides a function of managing a communication status, by suppressing execution of scale-out such as addition or migration of a VNF 200, deterioration of the performance of the communication service can be suppressed.

The VM control part in the control part 210c in FIG. 13 can allocate more resources than the resources set based on a request from the controller 6 to a VNF(s) 200 including the above communication status management function. Namely, by distributing extra resources to the VNF(s) 200, the VM control part in the control part 210c in FIG. 13 can suppress scale-out such as addition or migration of a VNF and avoid the above deterioration of the performance.

In addition, the VM control part in the control part 210c in FIG. 13 can control the resource amounts allocated to the VNFs 200 based on the update frequency of the communication status of the individual VNF 200. For example, the VM control part in the control part 210c in FIG. 13 may allocate extra resources to a VNF(s) 200 providing a function (for example, the PCEF of the virtual PGW 4A) whose communication status update frequency is high.

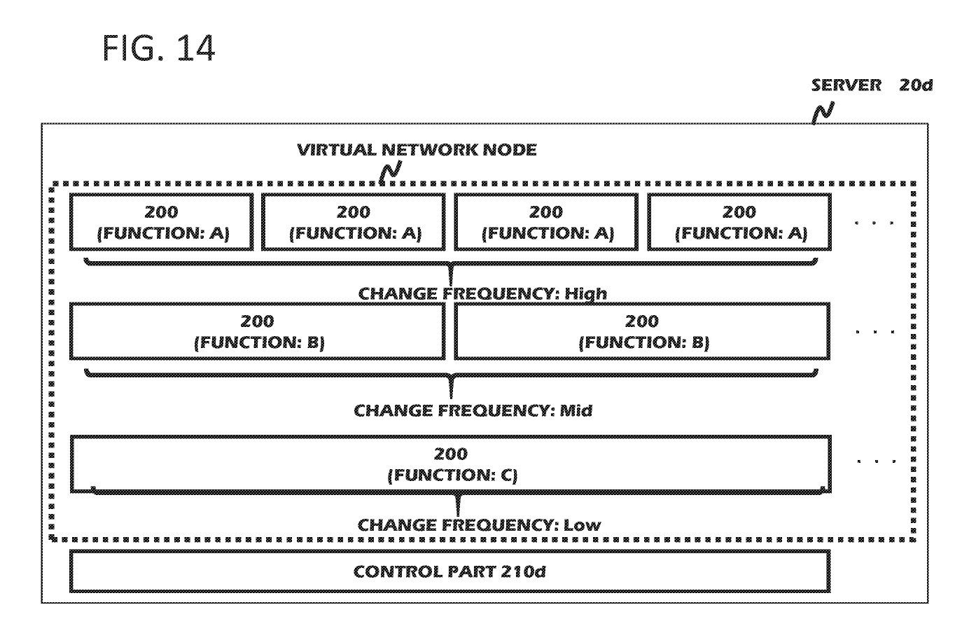

FIG. 14 illustrates another configuration example of the server 20 according to the first exemplary embodiment. A control part 210d can control the frequency of dynamic scaling (hereinafter, “change frequency”), such as addition or migration of a VNF 200, based on a function provided by a VNF 200.

Addition or migration of a VNF 200 is performed, for example, based on a request from the controller 6. A VM control part in the control part 210d in FIG. 14 controls the change frequency of a VNF, for example, by adjusting a load status threshold used for execution of addition or migration of a VNF 200.

The VM control part in the control part 210d in FIG. 14 controls the change frequency of a VNF, for example, based on whether the VNF has a communication status management function or based on the communication status change frequency. For example, when a VNF 200 includes a function of frequently updating a communication status (for example, the PCEF of the virtual PGW 4A), the VM control part in the control part 210d in FIG. 14 sets a lower change frequency for the VNF 200 than that set based on a request from the controller 6. In addition, for example, when a VNF 200 includes a function (for example, a U-Plane function) whose communication status update frequency is low, the VM control part in the control part 210d sets a higher change frequency for the VNF 200 than that set based on a request from the controller 6. When a VNF 200 includes a function whose communication status update frequency is low, the VM control part in the control part 210d may set the change frequency of the VNF 200 to be the same level as that of the change frequency set based on a request from the controller 6. By controlling the change frequency of an individual VNF in this way, deterioration of the performance due to scale-out of a VNF 200 can also be suppressed.

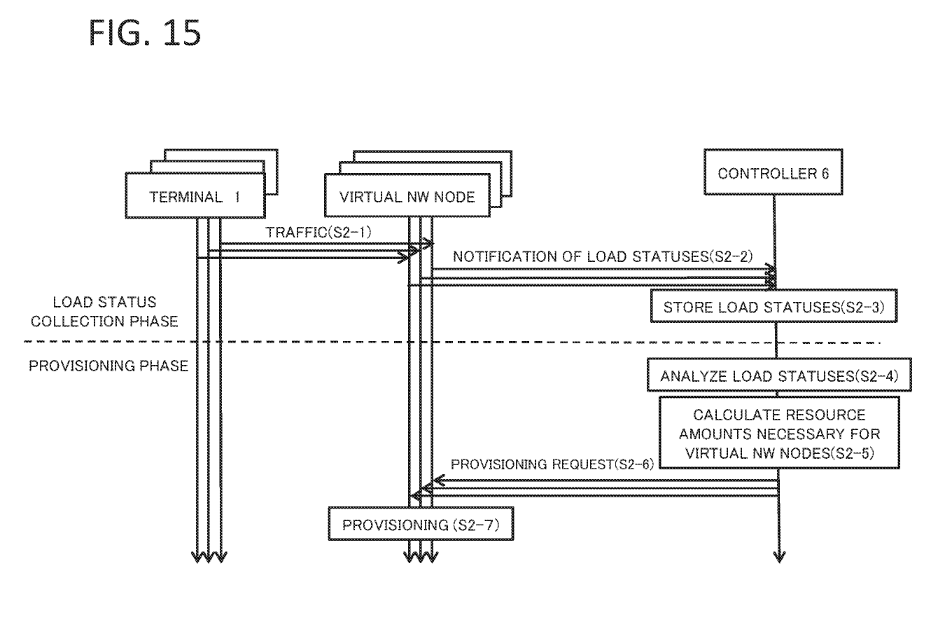

Next, an operation according to the present exemplary embodiment will be described in detail with reference to a drawing. FIG. 15 is a sequence diagram illustrating an operation according to the first exemplary embodiment. As illustrated in FIG. 15, terminals 1 perform communications via virtual network nodes (traffic in S2-1).

The terminals 1 transmit, for example, control signal and/or user data traffic to virtual network nodes. The virtual network nodes may transmit the control signal and/or user data traffic to other virtual network nodes. For example, the virtual eNB 2A transmits control signal traffic to the virtual MME 5A.

The control functions 201 in the virtual network nodes notify the controller 6 of the load statuses of their own virtual network nodes (S2-2). The control functions 201 notify the controller 6 of the load statuses of their own virtual network nodes, for example, at predetermined timing.

The control part 61A in the controller 6 stores the load statuses of the virtual network nodes in the load status storage part 60 (S2-3).

The control part 61A in the controller 6 analyzes the load statuses of the virtual network nodes stored in the load status storage part 60 (S2-4) and calculates resource amounts necessary for the virtual network nodes (S2-5).

Based on the resource amounts calculated by the control part 61A, the control part 61A in the controller 6 requests the server 20 operating virtual machines to allocate the resources to the corresponding virtual network nodes (request provisioning in S2-6). For example, based on the resource amounts of the virtual MME 5A calculated by the control part 61A, the control part 61A requests the server 20 to allocate the resources to the virtual MME 5A. When the virtual SGW 3A or the virtual PGW 4A belonging to the user plane has extra resources, the control part 61A instructs the server 20 to release the resources and allocate the released resources to the virtual MME 5A.

In response to the request from the controller 6, the control part 210 in the server 20 allocates the resource amounts based on the request to the virtual network nodes (provisioning in S2-7). For example, in response to the request from the controller 6, the control part 210 reduces the resources allocated to the virtual SGW 3A or the virtual PGW 4A and allocates the resource amounts corresponding to the reduction to the virtual MME 5A. In this way, it is possible to efficiently distribute the resources in the entire system.

As described above, according to the first exemplary embodiment, based on the load statuses of the devices that handle the control plane and the user plane among the virtual network nodes, the controller 6 calculates necessary resource amounts for these virtual network nodes and requests the server 20 operating virtual machines to redistribute the corresponding resource amounts. The server 20 adjusts the resource amounts in response to the request from the controller 6.

Thus, according to the first exemplary embodiment, when at least one of the devices handling the control plane and the user plane has extra resources, the load statuses of the virtual network nodes can be improved without using any additional resources. In addition, by performing appropriate provisioning, for example, virtual network processing delay or the like that occurs based on traffic characteristics such as burst traffic can be prevented. Of course, according to the first exemplary embodiment, when none of the devices that handle the control plane and the user plane have extra resources, resources may be acquired from a shared resource pool, and the acquired resources may be allocated.

In addition, while the first exemplary embodiment has been described assuming that the individual virtual network nodes actively notify the controller 6 of their respective load statuses, the controller 6 may query the individual virtual network nodes about their respective load statuses, to grasp the load statuses.

In addition, according to the first exemplary embodiment, resource amounts necessary for virtual network nodes to satisfy required performance are calculated, and the resource adjustment is performed based on the calculated resource amounts and based on the excess and deficiency states of the actually allocated resources. However, for example, the resource adjustment may be performed by moving physical resources from a virtual network node whose load status value is below a predetermined lower threshold to a virtual network node whose load status value is over a predetermined upper threshold.

### Second Exemplary Embodiment

Next, a second exemplary embodiment will be described. In the second exemplary embodiment, an NFV management and orchestration (NVF-MANO) apparatus having a VNF management function as a resource management apparatus is arranged in place of the controller 6 according to the first exemplary embodiment.

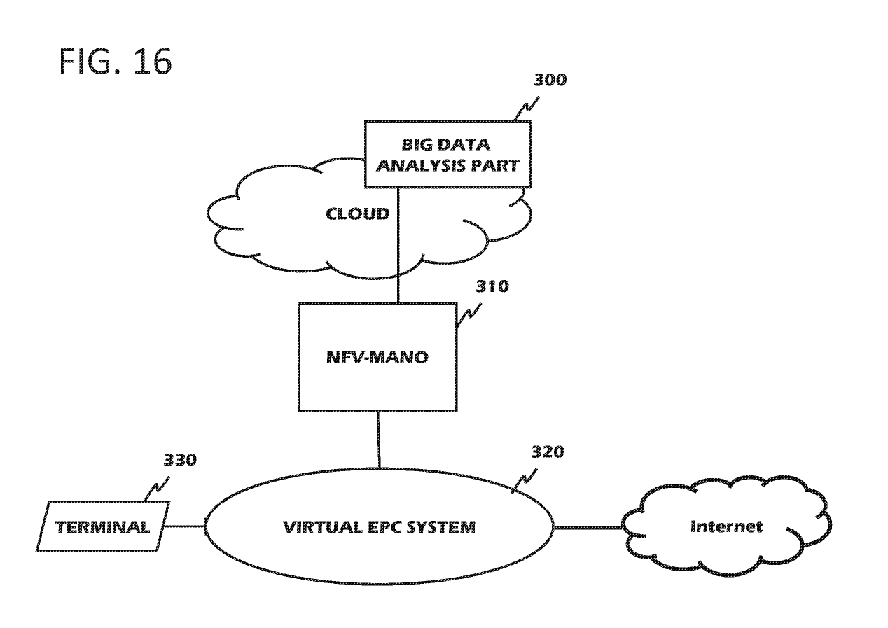

FIG. 16 illustrates an overall configuration according to a second exemplary embodiment of the present disclosure. According to the second exemplary embodiment, an NFV-MANO 310 transmits the load statuses of the monitoring target virtual network nodes in a virtual EPC system 320 to a big data analysis part 300 on a cloud (corresponding to the first section).

The big data analysis part 300 analyzes, for example, the real-time load statuses of the individual virtual network nodes and the load fluctuation over time in the past and transmits the analysis result to the NFV-MANO 310. The NFV-MANO 310 determines distribution of the resources to the individual virtual network nodes based on the analysis result from the big data analysis part 300 (corresponding to the second section).

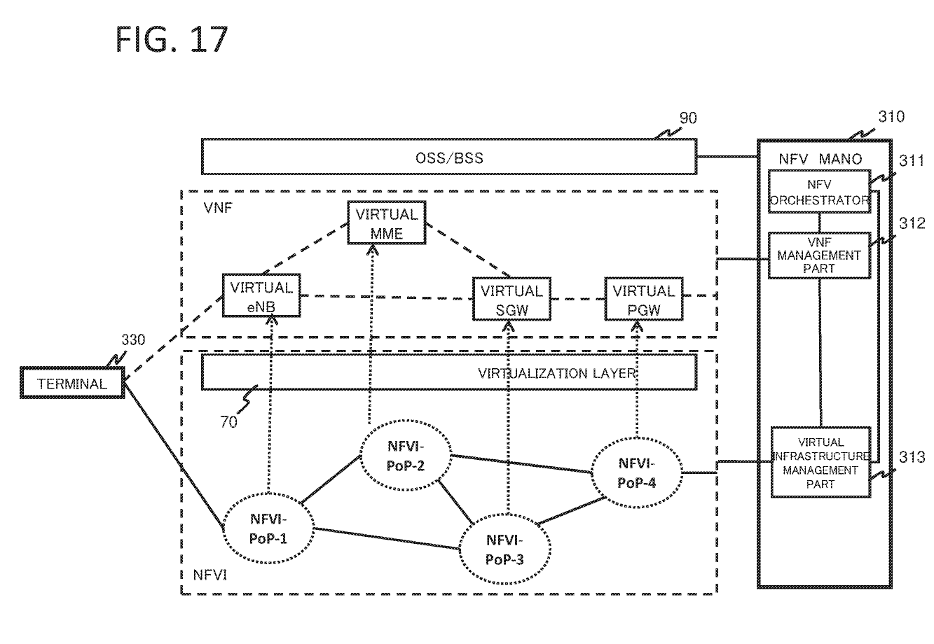

FIG. 17 illustrates an example in which a virtual EPC system is established by using a configuration of an End-to-End network service illustrated in section 6.2 Virtualisation of Functional Blocks for Network Services in Non-Patent Literature 2. The dotted circles at the bottom in FIG. 17 represent Network Function Virtualisation Infrastructure Point of Presence (NFVI-PoP), namely, physical hardware resources.

In addition, the NFV-MANO 310 includes an NFV orchestrator 311, a VNF management part 312, and a virtual infrastructure management part 313. The NFV orchestrator 311 controls the VNF management part 312 and the virtual infrastructure management part 313 based on instructions from an OSS/BSS (Operations Support System/Business Support System) 90.

The virtual infrastructure management part 313 uses physical resources such as the above NFVI-PoPs to establish a virtual infrastructure such as virtual computing, virtual storage, and virtual network resources on a virtualization layer 70 and provides the VNF management part 312 with the established virtual infrastructure. The virtual infrastructure management part 313 corresponds to the virtualised infrastructure manager (VIM) in Non-Patent Literatures 1 and 2.

The VNF management part 312 manages VNFs based on instructions from the NFV orchestrator 311. The VNF management part 312 corresponds to the VNF Manager in Non-Patent Literatures 1 and 2.

In addition, according to the present exemplary embodiment, the

NFV-MANO 310 determines distribution of the resources to the virtual network nodes such as a virtual MME, a virtual SGW, and a virtual PGW based on the analysis result from the big data analysis part 300.

Next, an operation according to the present exemplary embodiment will be described. For example, when the NFV orchestrator 311 in the NFV-MANO 310 according to the second exemplary embodiment recognizes that an IoT service has been requested, the NFV orchestrator 311 monitors the load statuses of the virtual MME, the virtual SGW, and the virtual PGW among the VNFs.

As a result of the monitoring, when the NFV orchestrator 311 detects that the load of the virtual MME has exceeded a preset threshold, the virtual MME notifies the NFV orchestrator 311 of the excess load via the VNF management part 312.

When notified of the excess load, when the user-plane load status of the virtual SGW and/or the virtual PGW indicates a preset threshold or less, the NFV orchestrator 311 instructs the VNF management part 312 and the virtualized infrastructure management part 313 to distribute the resources allocated to the virtual SGW and/or the virtual PGW to the virtual MME.

As described above, according to the second exemplary embodiment, as in the first exemplary embodiment, when the resources of a virtual MME processing the control plane is insufficient, the resources of a virtual SGW and/or a virtual PGW processing the user plane can be distributed to the virtual MME. Thus, it is possible to maintain the required performance as a whole while suppressing increase in the resources used in the entire system.

In addition, when the resources of the virtual SGW or the virtual PGW that processes the user plane is insufficient, the resources of the virtual MME that processes the control plane can be distributed to the virtual SGW or the virtual PGW. In this way, it is possible to maintain the required performance as a whole while suppressing increase in the resources used in the entire system.

When the load of the virtual MME exceeds a preset second threshold (higher than the threshold that corresponds to the start of the above resource distribution), resources may be acquired from a shared virtual node pool (a resource pool). In addition, when the resource load of the virtual MME, the virtual SGW, or the virtual PGW falls below the preset threshold, relevant resources may be returned to the shared virtual node pool (the resource pool).

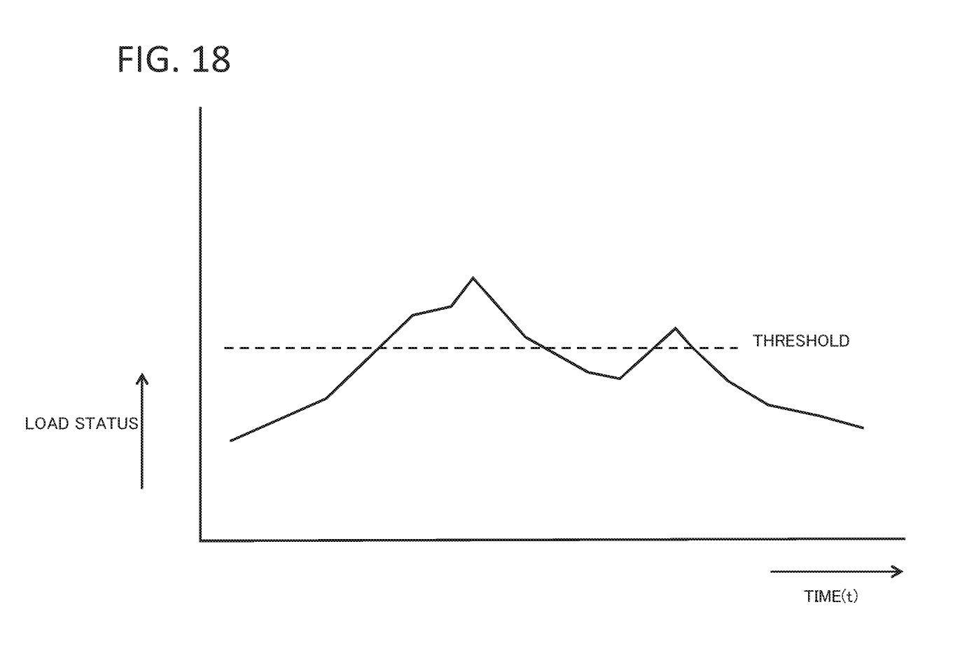

FIG. 18 illustrates an example of fluctuation of the load of a virtual network node. The load status of an individual node is expected to fluctuate over time. The above big data analysis part 300 may store the load fluctuation status of an individual virtual node in a memory for a certain period, analyze the fluctuation status, and predict when the load of the virtual network node will exceed a threshold next. The big data analysis part 300 may notify the NFV-MANO 310 of the prediction result. In this way, it is possible to cause the NFV-MANO 310 to perform resource allocation in view of the future load increase.

An individual part (processing section) of the devices and apparatuses illustrated in the drawings used to describe the first and second exemplary embodiments can be realized by a computer program that causes a computer constituting the corresponding device or apparatus to use its hardware and perform corresponding processing described above.

While exemplary embodiments of the present invention have thus been described, the present invention is not limited thereto. Further variations, substitutions, or adjustments can be made without departing from the basic technical concept of the present invention. For example, the configurations of the networks, the configurations of the elements, and the representation modes of the messages illustrated in the drawings have been used only as examples to facilitate understanding of the present invention. Namely, the present invention is not limited to the configurations illustrated in the drawings.

For example, while the above exemplary embodiments have been described by using an example in which the present invention is applied to management of resources in a virtual mobile core network that can accommodate Long Term Evolution (LTE), the present invention can also be applied to management of resources in a virtual mobile core network that can accommodate a 3G network. In this case, the management entity that handles the control plane is a home location register (HLR)/home subscriber server (HSS). The gateway that handles the user plane is a device such as a Serving GPRS Support Node (SGSN), a Gateway GPRS Support Node (GGSN), or an xGSN that integrates the SGSN and the GGSN (GPRS is an acronym of General Packet Radio Service).

Finally, suitable modes of the present invention will be summarized.

### [Mode 1]

(See the resource management apparatus according to the above first aspect)

### [Mode 2]

The resource management apparatus may calculate, based on the load statuses of the virtual first and second devices, necessary resource amounts such that values indicating the load statuses of the virtual first and second devices satisfy predetermined conditions; and

the resource management apparatus may adjust physical resources allocated to the virtual first and second devices, based on excess or deficiency of the calculated resources.

### [Mode 3]

The virtual network may be a virtual network configured by virtualizing at least one management entity that handles the control plane and at least one gateway that handles the user plane; and

when a value that indicates a load status of a management entity virtualized as the first device is greater than a predetermined threshold, the second section may distribute a resource allocated to the virtual gateway that handles the user plane to the virtual management entity.

### [Mode 4]

The virtual network may be a virtual network configured by virtualizing at least one management entity that handles the control plane and at least one gateway that handles the user plane; and

when a value that indicates a load status of a gateway virtualized as the second device is greater than a predetermined threshold, the second section may distribute a resource allocated to the management entity that handles the control plane to the virtual gateway.

### [Mode 5]

The virtual network may be a virtual mobile core network configured by virtualizing an MME handling a control plane and a serving gateway and a packet data network gateway handling the user plane; and

the virtual mobile core network may be used to collect sensor data observed by predetermined sensor devices.

### [Mode 6]

(See the resource management method according to the above second aspect)

### [Mode 7]

(See the program according to the above third aspect)

Modes 6 and 7 can be expanded in the same way as mode 1 is expanded to modes 2 to 5.

The disclosure of each of the above Patent Literature and Non-Patent Literatures is incorporated herein by reference thereto. Variations and adjustments of the exemplary embodiments and the examples are possible within the scope of the overall disclosure (including the claims) of the present invention and based on the basic technical concept of the present invention. Various combinations and selections of various disclosed elements (including the elements in the claims, exemplary embodiments, examples, drawings, etc.) are possible within the scope of the disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

What is claimed is:

1. A resource management apparatus, comprising:
a first section for monitoring, in a virtual network configured by virtualizing at least one first device that handles a control plane of the network and at least one second device that handles a user plane of the network, load statuses of the virtual first and second devices; and
a second section for adjusting physical resources allocated to the virtual first and second devices, based on the load statuses of the virtual first and second devices.

2. The resource management apparatus according to claim 1;
wherein the second section calculates, based on the load statuses of the virtual first and second devices, necessary resource amounts such that values indicating the load statuses of the virtual first and second devices satisfy predetermined conditions; and
wherein the second section adjusts physical resources allocated to the virtual first and second devices, based on excess or deficiency of the calculated resources.

3. The resource management apparatus according to claim 1;
wherein the virtual network is a virtual network configured by virtualizing at least one management entity that handles the control plane and at least one gateway that handles the user plane; and
wherein, when a value that indicates a load status of a management entity virtualized as the first device is greater than a predetermined threshold, the second section distributes a resource allocated to the virtual gateway that handles the user plane to the virtual management entity.

4. The resource management apparatus according to claim 1;
wherein the virtual network is a virtual network configured by virtualizing at least one management entity that handles the control plane and at least one gateway that handles the user plane; and
wherein, when a value that indicates a load status of a gateway virtualized as the second device is greater than a predetermined threshold, the second section distributes a resource allocated to the management entity that handles the control plane to the virtual gateway.

5. The resource management apparatus according to claim 1;
wherein the virtual network is a virtual mobile core network configured by virtualizing an MME handling a control plane and a serving gateway and a packet data network gateway handling the user plane; and
wherein the virtual mobile core network is used to collect sensor data observed by predetermined sensor devices.

6. A resource management method, comprising:
causing a resource management apparatus connected to a virtual network configured by virtualizing at least one first device that handles a control plane of the network and at least one second device that handles a user plane of the network to monitor load statuses of the virtual first and second devices; and
causing the resource management apparatus to adjust physical resources allocated to the virtual first and second devices, based on the load statuses of the virtual first and second devices.

7. The resource management method according to claim 6;
wherein, based on the load statuses of the virtual first and second devices, necessary resource amounts are calculated such that values indicating the load statuses of the virtual first and second devices satisfy predetermined conditions; and
wherein physical resources allocated to the virtual first and second devices are adjusted based on excess or deficiency of the calculated resources.

8. The resource management method according to claim 6;
wherein the virtual network is a virtual network configured by virtualizing at least one management entity that handles the control plane and at least one gateway that handles the user plane; and
wherein, when a value that indicates a load status of a management entity virtualized as the first device is greater than a predetermined threshold, a resource allocated to the virtual gateway that handles the user plane is distributed to the virtual management entity in the adjustment.

9. The resource management method according to claim 6;
wherein the virtual network is a virtual network configured by virtualizing at least one management entity that handles the control plane and at least one gateway that handles the user plane; and
wherein, when a value that indicates a load status of a gateway virtualized as the second device is greater than a predetermined threshold, a resource allocated to the management entity that handles the control plane is distributed to the virtual gateway.

10. A non-transitory computer-readable recording medium storing thereon a program, causing a computer constituting a resource management apparatus connected to a virtual network configured by virtualizing at least one first device that handles a control plane of the network and at least one second device that handles a user plane of the network to perform processing for:
monitoring load statuses of the virtual first and second devices; and
adjusting physical resources allocated to the virtual first and second devices, based on the load statuses of the virtual first and second devices.

11. The resource management apparatus according to claim 2;
wherein the virtual network is a virtual network configured by virtualizing at least one management entity that handles the control plane and at least one gateway that handles the user plane; and
wherein, when a value that indicates a load status of a management entity virtualized as the first device is greater than a predetermined threshold, the second section distributes a resource allocated to the virtual gateway that handles the user plane to the virtual management entity.

12. The resource management apparatus according to claim 2;
wherein the virtual network is a virtual network configured by virtualizing at least one management entity that handles the control plane and at least one gateway that handles the user plane; and
wherein, when a value that indicates a load status of a gateway virtualized as the second device is greater than a predetermined threshold, the second section distributes a resource allocated to the management entity that handles the control plane to the virtual gateway.

13. The resource management apparatus according to claim 3;
wherein the virtual network is a virtual network configured by virtualizing at least one management entity that handles the control plane and at least one gateway that handles the user plane; and
wherein, when a value that indicates a load status of a gateway virtualized as the second device is greater than a predetermined threshold, the second section distributes a resource allocated to the management entity that handles the control plane to the virtual gateway.

14. The resource management apparatus according to claim 2;
wherein the virtual network is a virtual mobile core network configured by virtualizing an MME handling a control plane and a serving gateway and a packet data network gateway handling the user plane; and
wherein the virtual mobile core network is used to collect sensor data observed by predetermined sensor devices.

15. The resource management apparatus according to claim 3;
wherein the virtual network is a virtual mobile core network configured by virtualizing an MME handling a control plane and a serving gateway and a packet data network gateway handling the user plane; and
wherein the virtual mobile core network is used to collect sensor data observed by predetermined sensor devices.

16. The resource management apparatus according to claim 4;
wherein the virtual network is a virtual mobile core network configured by virtualizing an MME handling a control plane and a serving gateway and a packet data network gateway handling the user plane; and
wherein the virtual mobile core network is used to collect sensor data observed by predetermined sensor devices.

17. The resource management method according to claim 7;
wherein the virtual network is a virtual network configured by virtualizing at least one management entity that handles the control plane and at least one gateway that handles the user plane; and
wherein, when a value that indicates a load status of a management entity virtualized as the first device is greater than a predetermined threshold, a resource allocated to the virtual gateway that handles the user plane is distributed to the virtual management entity in the adjustment.

18. The resource management method according to claim 7;
wherein the virtual network is a virtual network configured by virtualizing at least one management entity that handles the control plane and at least one gateway that handles the user plane; and
wherein, when a value that indicates a load status of a gateway virtualized as the second device is greater than a predetermined threshold, a resource allocated to the management entity that handles the control plane is distributed to the virtual gateway.

19. The resource management method according to claim 8;
wherein the virtual network is a virtual network configured by virtualizing at least one management entity that handles the control plane and at least one gateway that handles the user plane; and
wherein, when a value that indicates a load status of a gateway virtualized as the second device is greater than a predetermined threshold, a resource allocated to the management entity that handles the control plane is distributed to the virtual.
